(19) United States
(12) Patent Application Publication
(10) Pub. No.: US 2011/0164052 A1
(43) Pub. Date: Jul. 7, 2011

(54) COMPOSITIONAL STRUCTURE, MECHANISMS AND PROCESSES FOR THE INCLUSION OF BINOCULAR STEREO INFORMATION INTO REPRESENTATIONAL MEDIA

(76) Inventor: John Jupe, Somerset (GB)

(21) Appl. No.: 13/054,966

(22) PCT Filed: Jul. 17, 2009
(86) PCT No.: PCT/GB2009/001787

§ 371 Date: Mar. 24, 2011

Related U.S. Application Data
(60) Provisional application No. 61/135,728, filed on Jul. 23, 2008.

(51) Int. Cl. G09G 5/00

(52) U.S. Cl. 345/629

(57) ABSTRACT

A method of enhancing the perception of an image is described which comprises the steps of: a. selecting a picture or graphic representation for enhancement; b. producing two monocular images: i. monocular image one is a left hand view; ii. monocular image two is a right hand view; iii. the point of observation for monocular image one and monocular image two are separated by a horizontal distance of approximately 1 centimeter to 1 meter; c. creating peripheral monocular extents within the peripheral zone (Zone 1) by: i. aligning said left hand and right hand peripheral data sets such that the fixation points of the left hand view and right hand view are coincident; ii. excluding all elements of the two data sets which are in common; d. creating a central binocular zone (Zone 2) by: i. selecting the right hand central data set as the dominant central data set; ii. overlaying and integrating said dominant central data set with the remaining central data set; e. creating a binocular field (Zone 3) by: i. aligning said left hand and right hand peripheral data sets such that the fixation points of the left hand view and right hand view are coincident; ii. including only those elements of the two data sets which are in common; and f. overlaying and integrating the Zone 1, Zone 2 and Zone 3.

### BACKGROUND

This invention relates to a method of reconfiguring data, obtained optically (camera) and by other means (Depthmapping), to generate information streams and modulations of information replicating those appearing in our presentations of vision when confronted with actual 3D scenes. Seeking to enhance optical projection and seeking to achieve ‘as seen’ presentations of the world can be thought of as fundamentally different pursuits. Replicating ‘as seen’ or ‘experiential reality’ involves the creation of an altogether new form of illusionary space. This has been termed Vision-Space as opposed to picture space (optical structure & central perspective).

When presented in image form, this new media structure (Vision-Space) provides the viewer with representations of experiential reality: how we would have encountered the real scene. Vision-Space provides the essential characteristics of a subjective view; ‘how’ we encounter the world. This is in marked contrast to the provision of a modelled 3D virtual reality merely designed to fool us into believing that there is a 3D scene to be perceived or the projection of the purely optical objectivity of the scene provided by the camera.

Attempts are currently made in post process to ‘enhance’ picture media, but none of these work from the base understanding identified in Vision-Space. Some of these processes attempt to work towards it but with inappropriate methodologies and with varying degrees of success.

Without understanding perceptual structure and configuring media in accordance with the processes involved in visual perception, it is not possible to create truly (experientially accurate) immersive representational media and environments. This is true right across the board from 2D images to 3D images and across all the industries that use them.

For representational media to be truly immersive, it must include the processes that contribute to the experiential saliency of vision.

The brain receives visual information about the world from both eyes. Receptors in each eye respond to photons in the light array (radiance). Converted to a flow of what should be considered to be a largely unstructured signal, electromagnetic impulses are streamed from the ganglion cells in the retina down two neural pathways to various areas of the brain for segmentation into cue formation and subsequent cascade and evaluation/conscious awareness. This process identifies that the segmentation of information from the light array starts from the very first point of entry into the visual system.

The optic nerve has a channel capacity of around 10 to power 8 to 9 bits per second. Estimates of the structural complexity of perceptions are generally below 100. The many orders of magnitude gap indicates that there must be underlying structures and that information making up our perceptions at any one time must be highly selective.

From intuitive study of the actual phenomenon of vision (as it is presented to us) by visual artists and by psychophysical experimentation, it is possible to become aware of the underlying structures involved. These are here collectively termed ‘perceptual structure’. These structures identify that vision differs significantly from the structure of optics appreciated in photographs from mechanical devices such as the camera. Using these unique ecological structures, our mind selects and composes our presentations of vision that are fragmented and composed using the segmented information to best accommodate our actions and intent, as described. in The theory of multistage integration in the visual brain—A Bartels and S. Zeki Royal Society 1998.

The formation of cues allows us to develop over time, a visual appreciation of the world from a largely unstructured chaotic stream of information. The promotion of information to ‘cue’ status is more a process of ‘diagnostics’ than it is dataprojection'.

With the underlying processes understood (with the associated mathematical definition) and matched to the intuitive evaluations made directly from studying visual experience (the work of visual artists and vision scientists), it becomes possible to reference this highly specialist ‘perceptual structure’ within representational media. This transformation process makes the media more immersive and enables us to realistically portray scenes as, ‘as seen’ experience. In other words, it becomes possible to restructure representational media gathered by optical devices such as the camera, to match experiential reality. This new form of illusionary space is referred to herein as Vision-Space. The transformation processes form the subject of a series of patents and patent applications.

To gain the increased immersive advantages from Vision-Space media, it is not necessary to wear fusing glasses or to screen information on specialist screens. The 3D impressions we experience as part of vision are contained within our actual presentations of vision and the same is true of Vision-Space media—they can be embedded within the media. If the media is structured correctly, 3D, as experience in our normal presentations of vision, can be replicated on a 2D screen without additional aids.

### SUMMARY OF INVENTION

This patent establishes how binocular stereo information can be embedded in monocular Vision-Space media (or with variation in photographic structure). The technology has the ability to replace all forms of fusion technology as the preferred method of 3D presentation. It also has the capacity to work along side binocular fusion technologies in areas where the existing technology fails or breaks down (peripheral areas).

The process of converting picture media and depth-map data to form a working representation of monocular vision is set out in patent GB2400259 and provisional application “METHOD AND SOFTWARE FOR TRANSFORMING IMAGES” (US Patent and Trademark Office provisional application No. 60/963,052 filed Aug. 2, 2007).

The present invention establishes the processes whereby binocular stereo information (from a second camera (slightly spatially off set to the left or right from the first, but trained on the same area of a scene), can be embedded into monocular Vision-Space media to create representational media mimicking many of the main characteristics of binocular stereo advantage appreciable in vision.

It is equally possible to use the processes outlined in this application with regular optical stereo pairs (photographic stills etc) to embed binocular stereo information in the same fashion.

The invention will further be described, by way of example, with reference to the accompanying drawings which are diagrams and photographs illustrating the effects of the invention.

### DETAILED DESCRIPTION OF INVENTION

Fragmentation of Visual Field/Fragmentation of the Image:

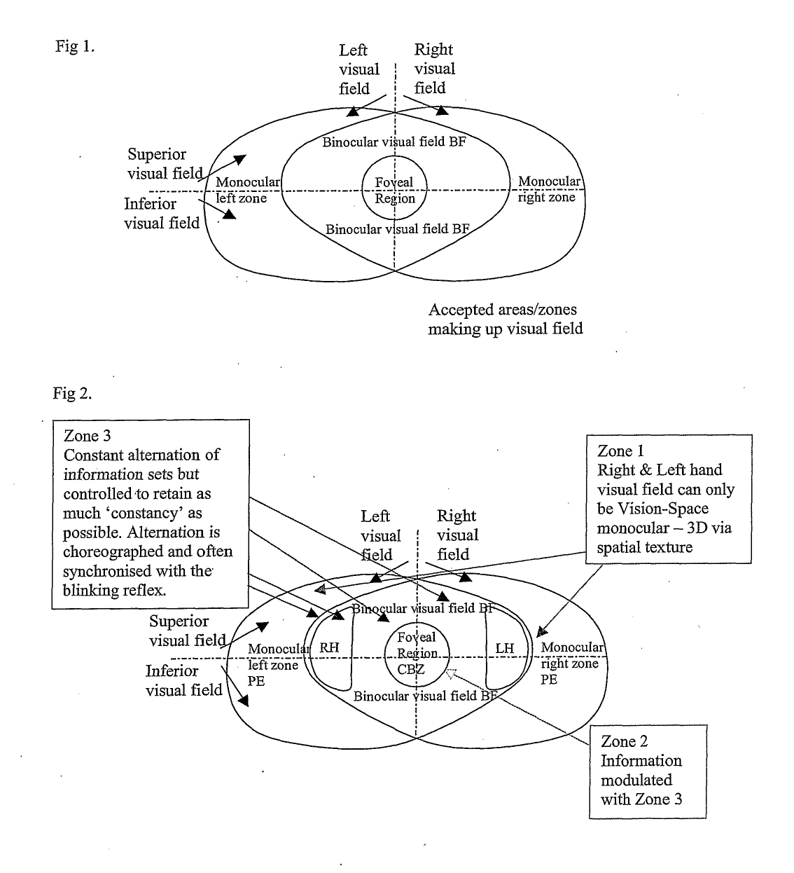

Given that our eyes are set apart on our face by a small distance it is clear that their view of the world will not exactly overlay one another. Visual field can be segmented as shown FIG. 1.

Broadly speaking, there are three main advantages from this arrangement.

1: The overall extent of visual field is increased in the extremities, left and right peripheral vision.
2: A central area of vision (binocular field—BF) can take advantage (in a variety of ways—Zone 2 &3 below) of the inherent binocular stereo capability.
3. Where information from both fields are available ‘conformation’ of spatial (and perhaps other) positioning can be obtained.

By understanding this together with the way that the mind deploys this information in the BF (central vision and area in peripheral vision where binocular information is available), the invention significantly enhances the 3D capability of monocular Vision-Space media.

This segmentation of visual field identifies 3 zone types:

Zone 1. Peripheral Extents (PE): At the extreme edges of visual field only monocular vision is available. Only independent monocular Vision-Space RH and LH views of the scene can be formulated.

Binocular Field (BF) contains 2 independent presentation systems for binocular stereo interpretations. These are:

Zone 2. Foveal region, Central Binocular Zone (CBZ): Conditions in central vision reveal spatially isolated variation of information sets (as below) modulated in a sophisticated and seamless way so as to appear to be ‘constant’ to all but the most acute of subjective evaluations.

Zone 3. Binocular Field (BF): The entire area over which binocular stereo information is available. This is the area subject to most ‘variable’ conditions involving embedded alternation and areas of visual field where information from one eye (single view) is embedded into information from the other eye (single view). Zone 2 activity is cascaded into (appears centrally within) Zone 3.

These zones are illustrated in FIG. 2.

Note:
Some of the binocular stereo embedding techniques can be used and adapted for use in picture space media (optical media).
Some of the structures and dynamic processes described can be applied to information/media derived from just one camera (monocular or non-binocular in origin): In both cases, the aim is portray/encode/embed the information within the structure of the representation itself.
We know that within the lateral geniculate nuclei that information from either eyes are layered, one over the other prior to being sent to V1 for further segmentation and cue developments. From intuitive study, the dynamic processes of visual presentation ensure that within the binocular field (BF), embedded and/or modulated stereo information can be suppressed in favour of information from the other eye. In visual perception we are constantly sampling information in different ways to extract relevant cues. Hence, Vision-Space modulates information in a time based imaging system where not all the information is contained in the presentation (image) at any one time. Visual cues amass over time. (it is already well appreciated that camera movement provides strong 3D cues for 2D moving picture media)

Peripheral Extents (PE):

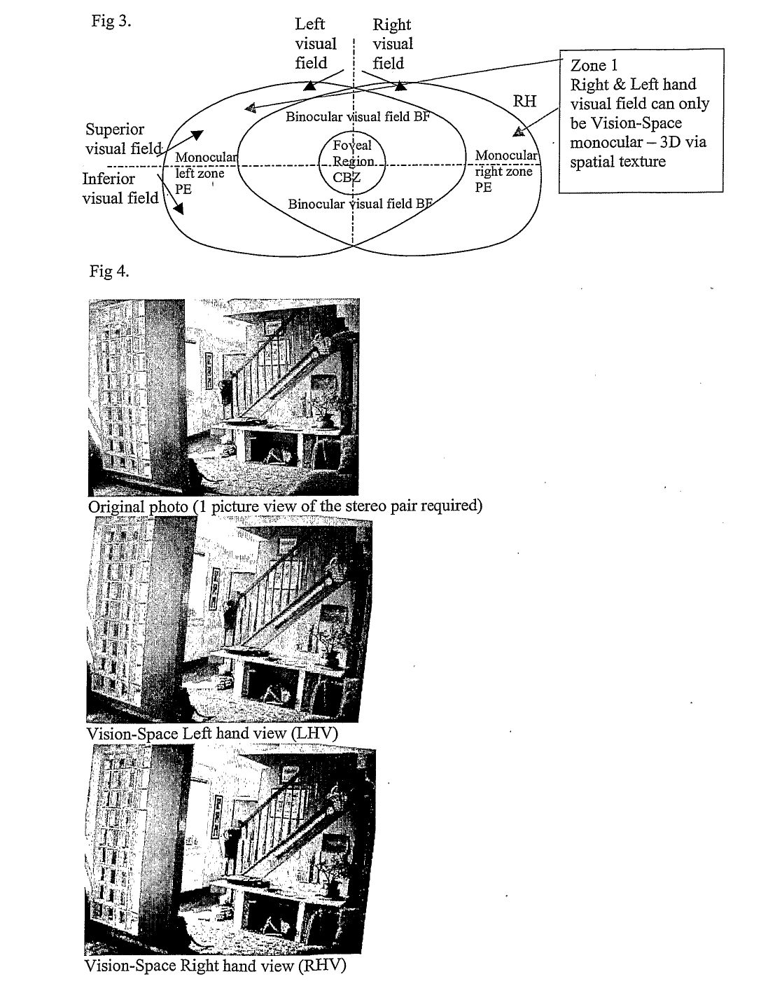

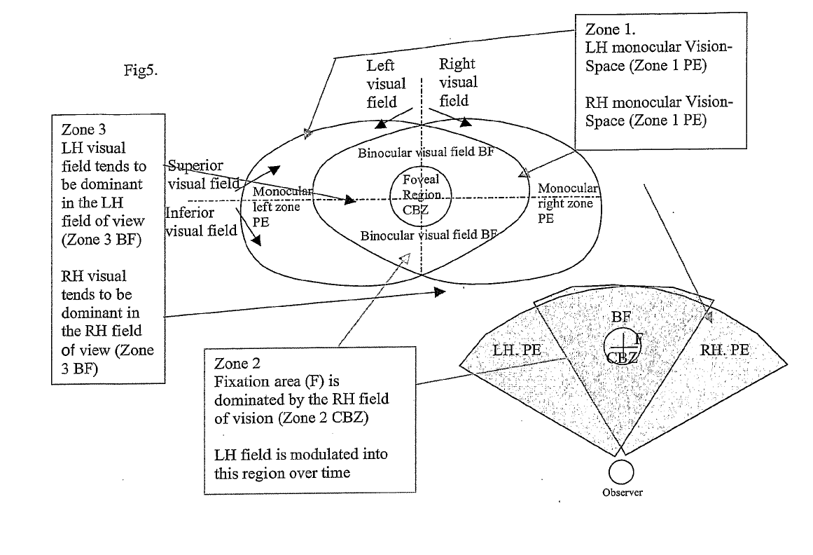

Referring to FIGS. 3 and 4, representational media that has information fed from 2 cameras (2 views of the scene) can be configured to replicate this composite structure in outlying/peripheral areas. Each independent view can be structured as a 3D field of disordered information set out from the object identified as the fixation point ‘F’. This form of monocular 3D provides significant orientation and proximity cues, as described in GB2400259.

Binocular Field (Zone 2&3):

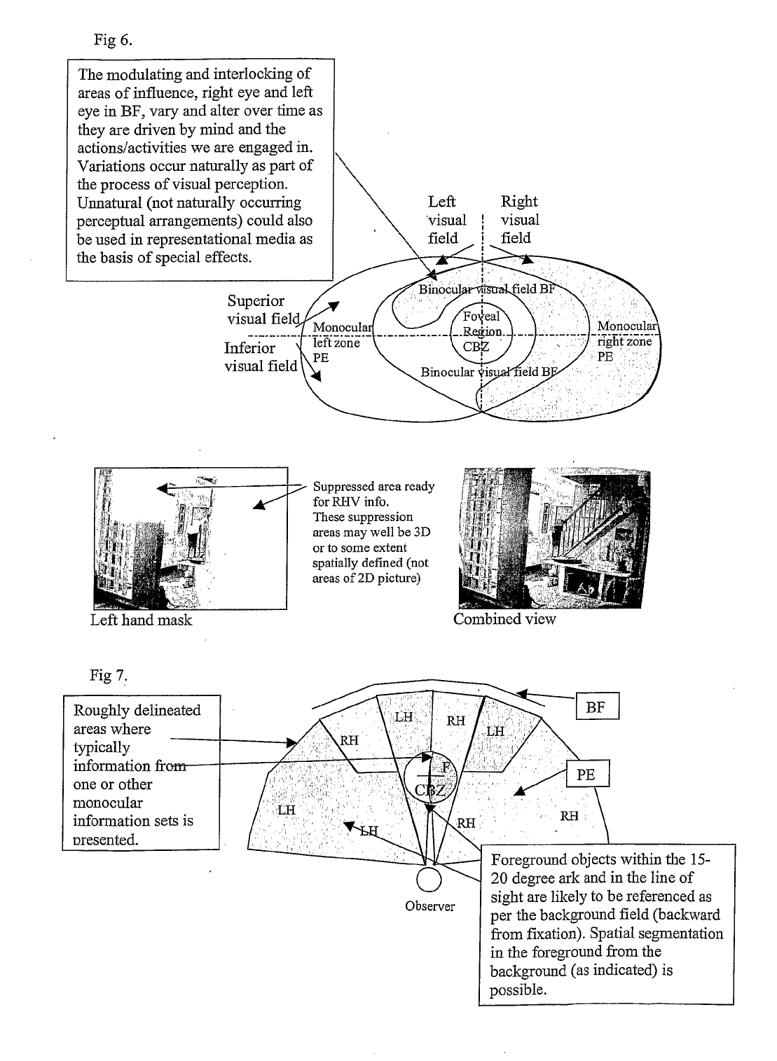

Referring to FIGS. 5 to 8, independent monocular 3D structures in the binocular field can interlock with each. Where one area is dominated by information coming from one view the other information set is suppressed and vice versa.

Representational media can be made to replicate these modulating and embedding mechanisms within the binocular filed (BF). The process identifies that visual binocular stereo within the phenomenon of vision, is not achieved by ‘fusion’ (of two pictures of the scene) but through integration, juxtaposition, modulation and composition, over time, of streamed information. Further functionality to the model enables the media to switch or modulate the dominant influence between RH and LH within this field. The dominance of one side or the other (RH/LH) may be linked to the ‘leading eye’ structure of vision and also addresses important issues relating to the handling of parallax. Alternating between these influences, usually masked by the blinking reflex, can be designed to match the periodicity experienced in visual perception or to a formula to suit an observer's appreciation of transformed Vision-Space representational media. Other imaging techniques such as interlacing frames with different information sets can also be used to deliver impressions of both fields of view. Another arrangement has both influences apparent at all times with a varying degree of transparency between the information sets.

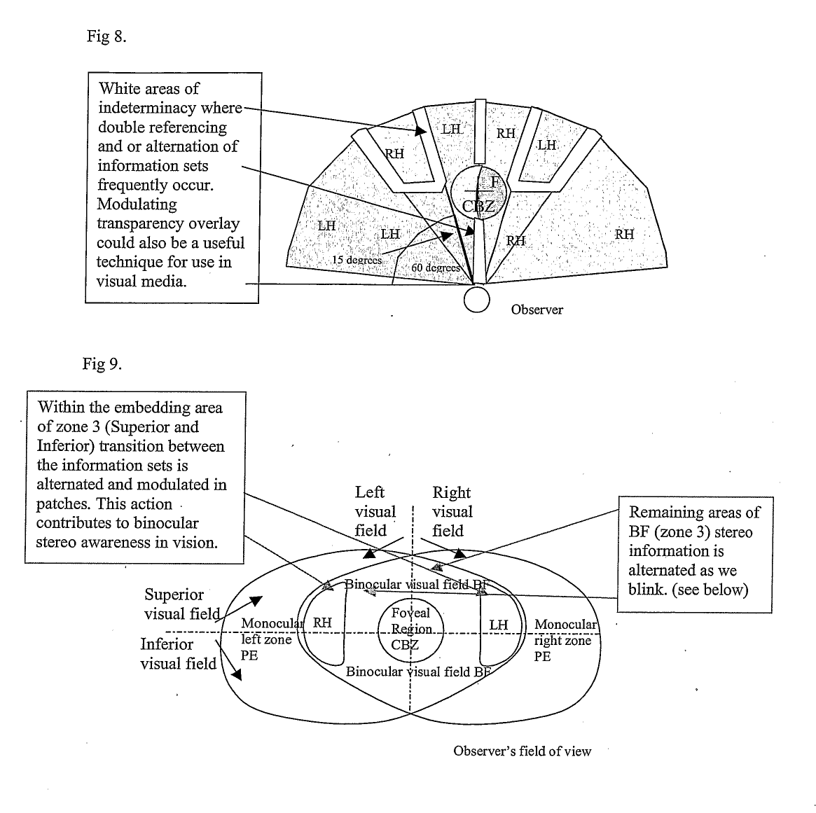

FIG. 8 shows a typically delineated arrangement of the monocular information sets showing areas of high indeterminacy in white.

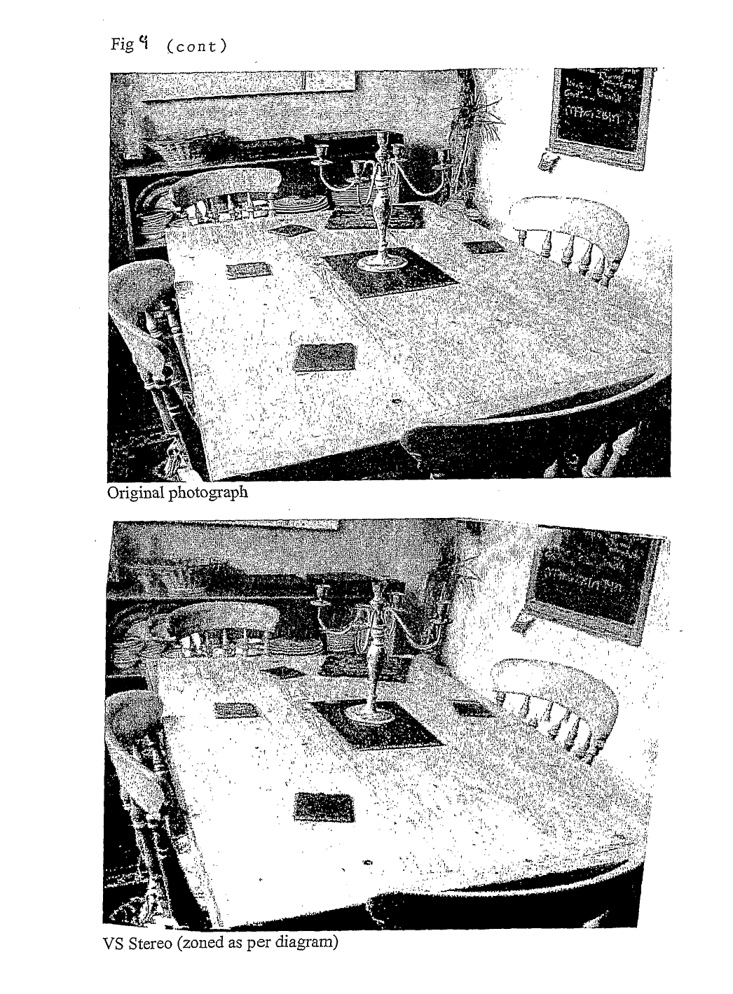

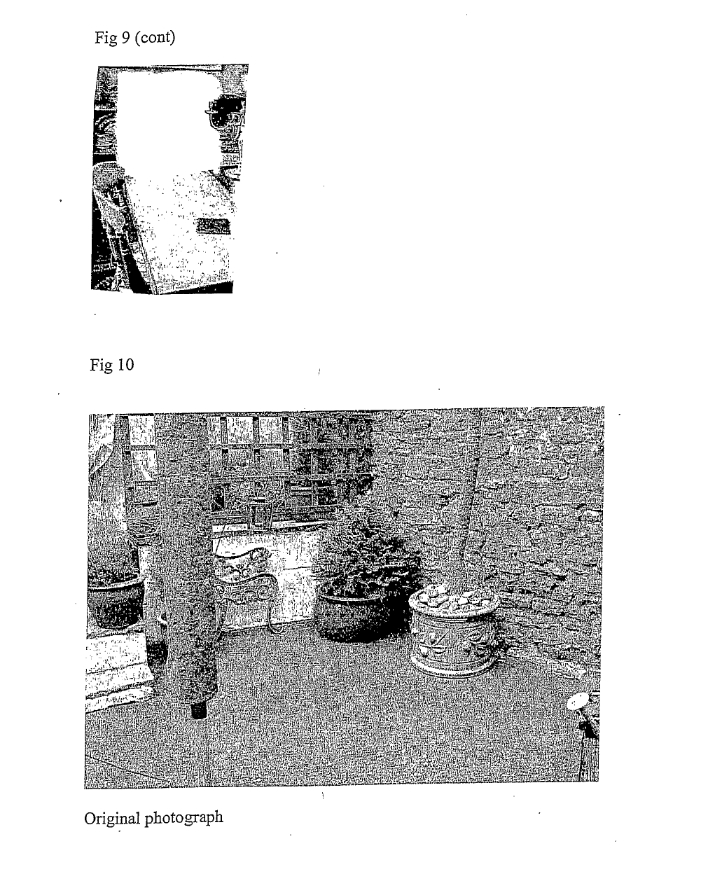

As shown in FIG. 9, a simple masking technique can be used to embed binocular stereo information into a single representation. The mask shows LH view information with an area removed where RH view information can then be introduced. An area of transparency has been indicated to provide a ‘merge’ modulation between the information sets.

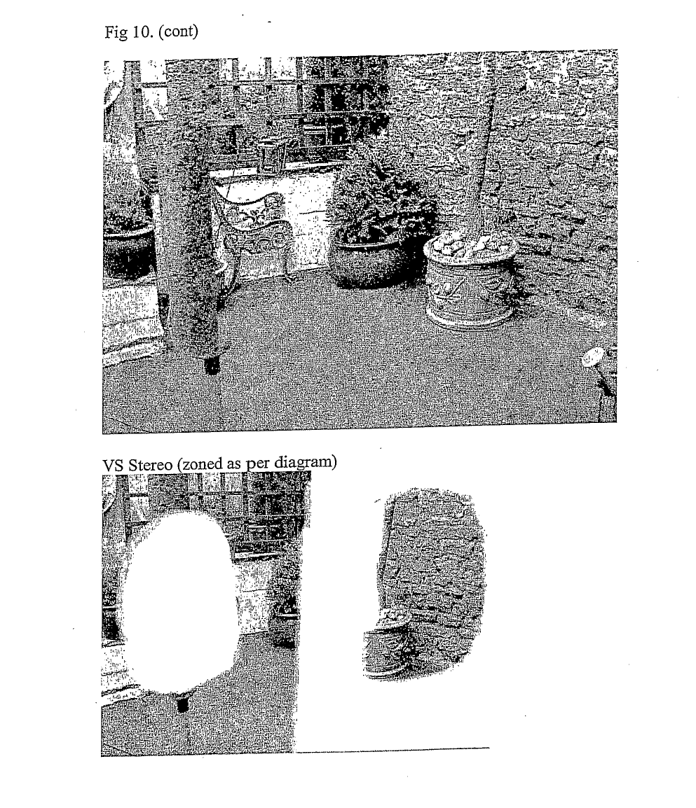

FIG. 10 illustrates the use of a simple masking technique used to embed binocular stereo information into a single Vision-Space representation. The mask shows LH view information with an area removed where RH view information can then be introduced. Also indicated on the left, the area of LH view that will appear embedded in the RH view.

A masking system is used to inset binocular stereo information into the representation mimicking the procedure apparent in visual perception. These specialist areas in peripheral visual field (outside fixation CBZ) can to some extent, be directed, in terms of position, shape and size. These areas contain a secondary form of attention (primary being central vision containing fixation). Manipulation of these zones is a low level and a largely unconscious act. However, it enables us to detect, sample and locate areas that are subsequently promoted to consciousness providing the signal to the primary form of attention to move to that area of visual field to carefully analyse the activity being picked up at that location (saccadic eye movement).

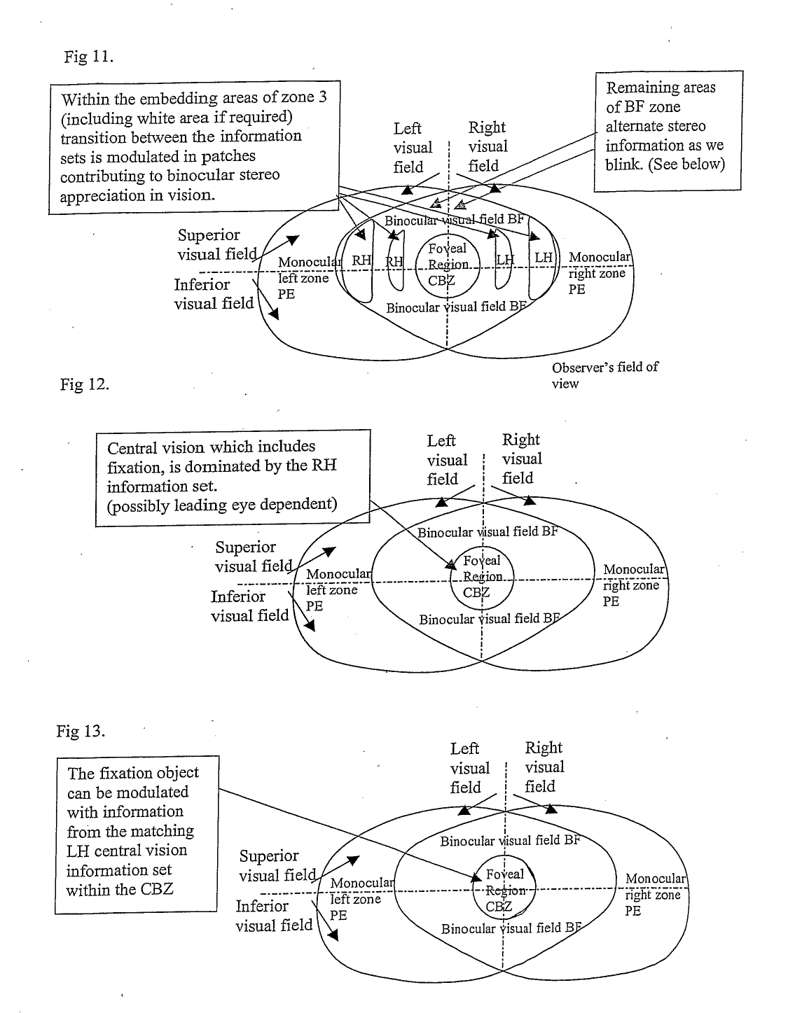

FIG. 11 is a diagram showing the splitting of the inset zone functions into 4 zones 2 for each side of visual field. The bottom half of these areas (inferior visual field) can be suppressed letting in information from the surrounding information sets. These arrangements have been plotted psychophysically as occurring in visual presentation, however variations can be made to suit the media.

These zones together with the mechanisms that drive their functionality are integrated into representational media to produce Vision Space media.

Fixation (Central Binocular Zone CBZ) Zone 2:

Referring to FIGS. 12 and 13, the adoption of these functions and structures provides representational media with the basic operation and functions in and around the selected fixation point to match processes apparent in visual presentation. The central binocular zone (CBZ) or fixation area is a spherical zone centred round the fixation point “F” (the object or part of the object held in fixation) and contains the high definition information. The RH eye (usually the leading eye) is dominant here but it also contains a sophisticated modulation function to enable information from both eyes to become seamlessly apparent at one time within the zone therefore achieving a high quality binocular stereo awareness within the region. These modulations take time and concentration to draw to consciousness.

It is important to visual perception that this area of vision, together with the area that immediately surrounds it, remains as perceptually constant as possible. By this we mean that changes are made subtly or imperceptibly. Mechanisms of merger or modulation are prevalent. Changes outside the zone can be more a matter of alternation (which appear to be less sophisticated and masked usually by the blinking reflex).

Although the effects are very different, this method of presentation mimicking the methods deployed in visual perception obviates the need for binocular fusion technologies. The Vision-Space system relies on the composition, juxtaposition, transparency and modulation between the various monocular Vision-Space information sets.

This ever-changing modulation function in vision places/cascades the high definition data as an information set(s) into the peripheral information set with its inherent 3D texture field. As indicated, the near spherical/circular information set in the foveal area swirls and slowly dilutes away, only to be reinstated and for the cycle to start again. In vision, the reinstatement usually occurs as we blink (blinking may be used to ‘mask’ the change process). In Vision Space media, these naturally occurring mechanisms of vision are applied and adapted (as algorithms) to suit the purpose. For example, it will be important in some circumstances to ensure that smooth and transparent transitions are engineered so as not to distract attention from the subject matter/content delivery of the presentation. Subtle modulations will mask more of the artefacts appearing in the media as a result of the transformations.

In specialist circumstances, as we take time to view an object, the mind creates a complex composite calling on information from both possible juxtaposed scenarios. This increased functionality adds to the information available to raise overall spatial and 3D awareness. Due to other distinctions apparent between the information sets, this process ensures that symmetrical objects, such as bottles and vases can appear to us in our presentations of vision as being asymmetrical. It is these so-called deformations (inconsistencies in shape and line etc.) apparent in vision (and the work of key visual artists) that show us flashes of the underlying perceptual structure used to generate the presentation.

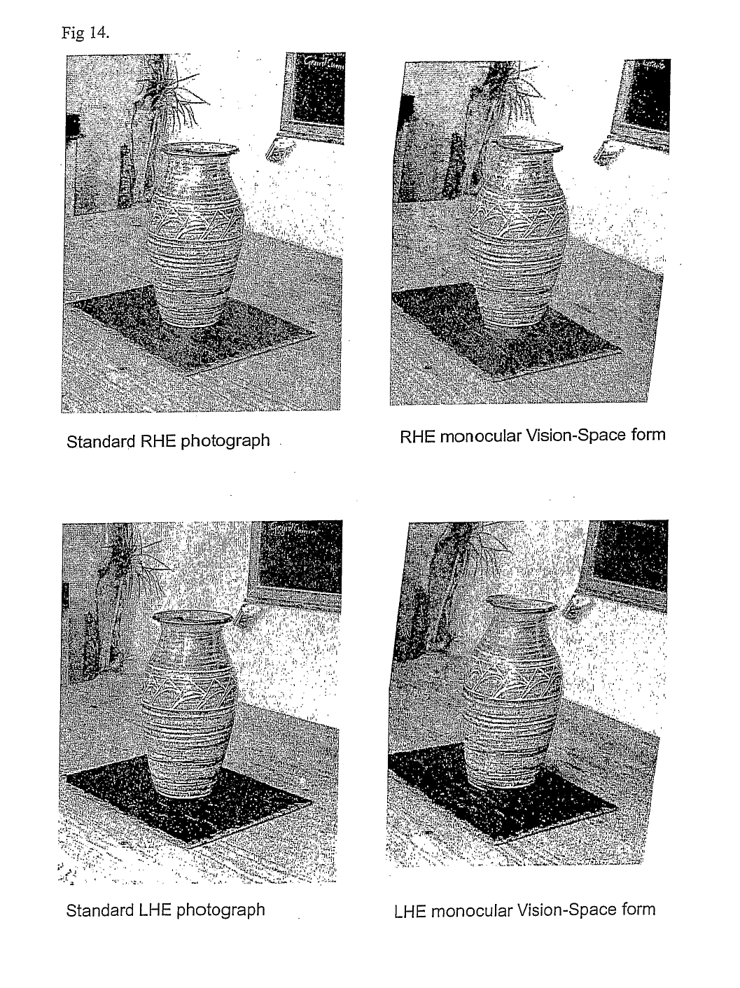

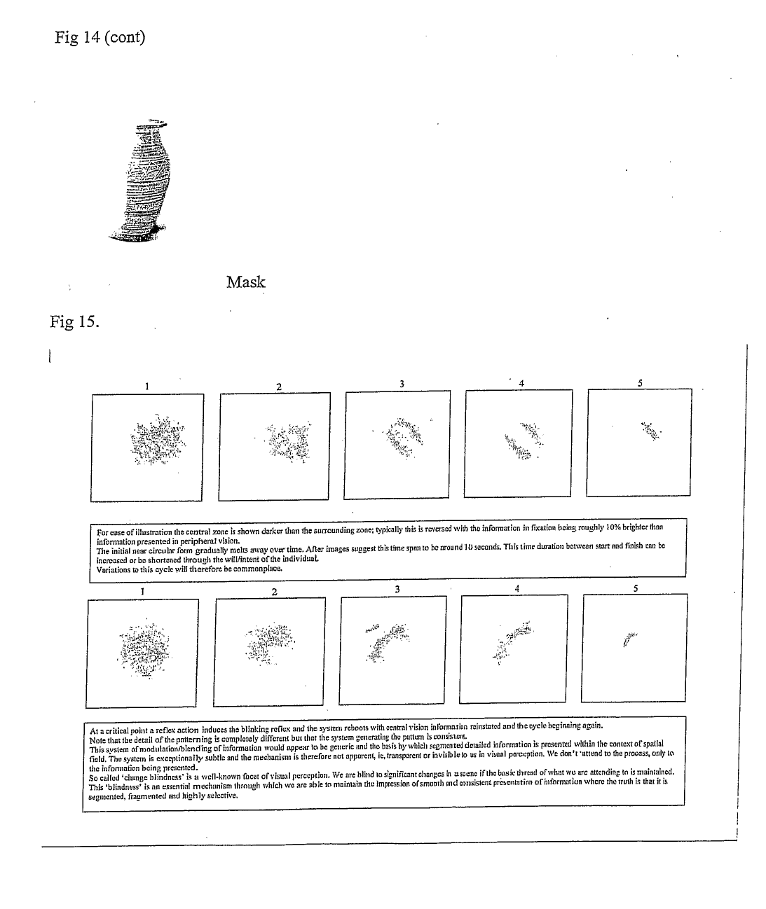

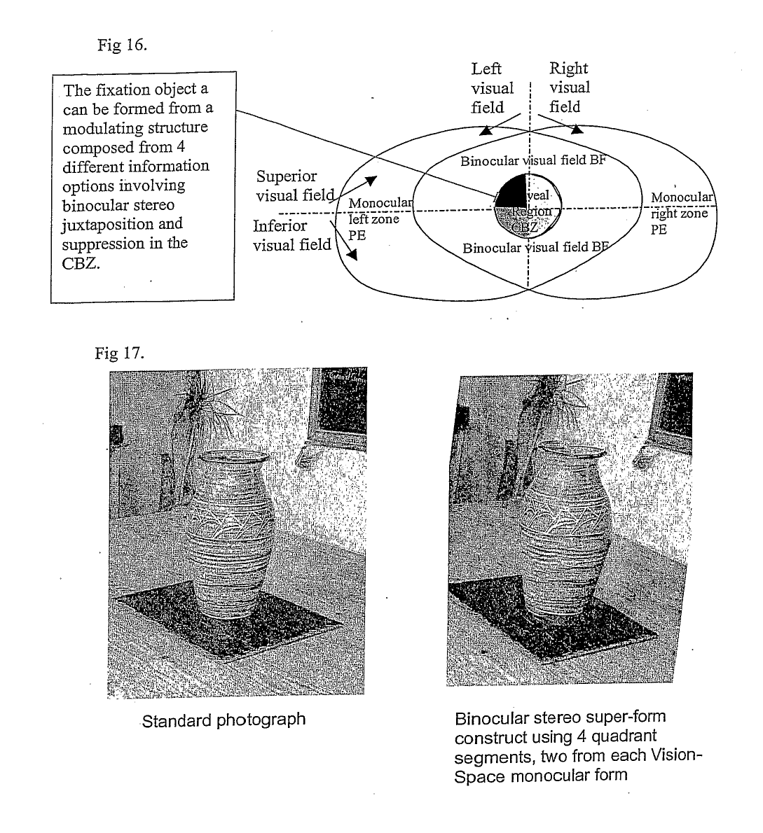

These individual factors identify that central vision can be formulated to include the modulation of 4 different information sets each bringing with it individually segmented data contributing to the ‘overall’ sense of object in space as shown in FIG. 16, and the results of this effect are shown in FIG. 17.

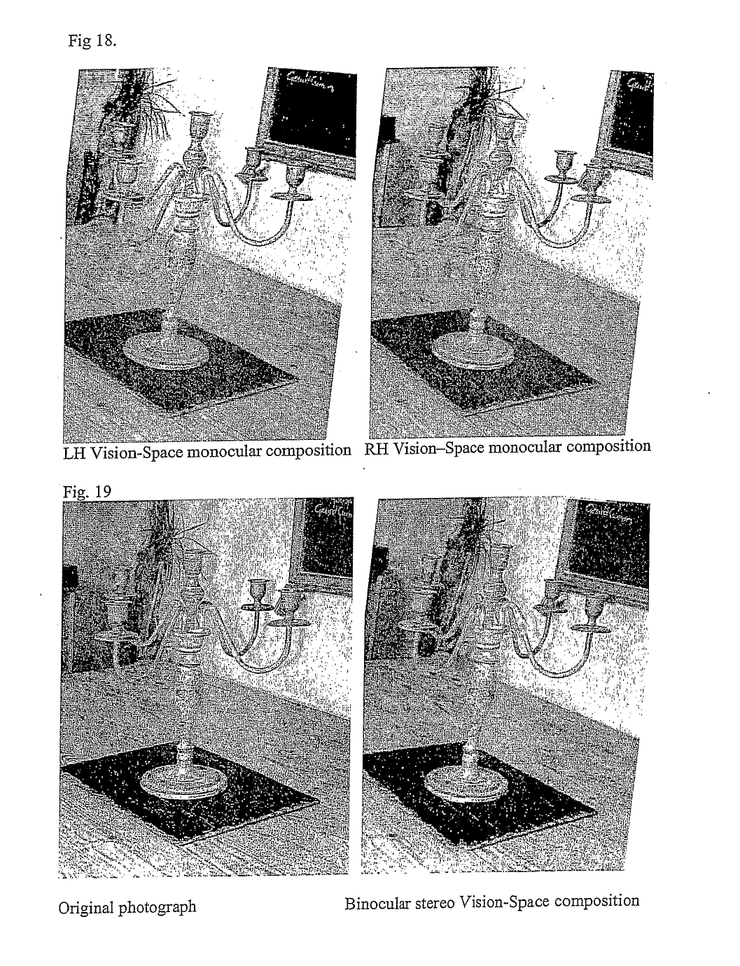

More complex forms appear to draw a more simplistic perceptual structure solution, as shown in FIGS. 18 and 19.

Note the vertical splice that has been made through the centre of the object and the immediate space around it. Revealed in the discontinuous line of the tabletop. This ‘step’ is evident in many paintings by artists like Cezanne, Van Gogh and others.

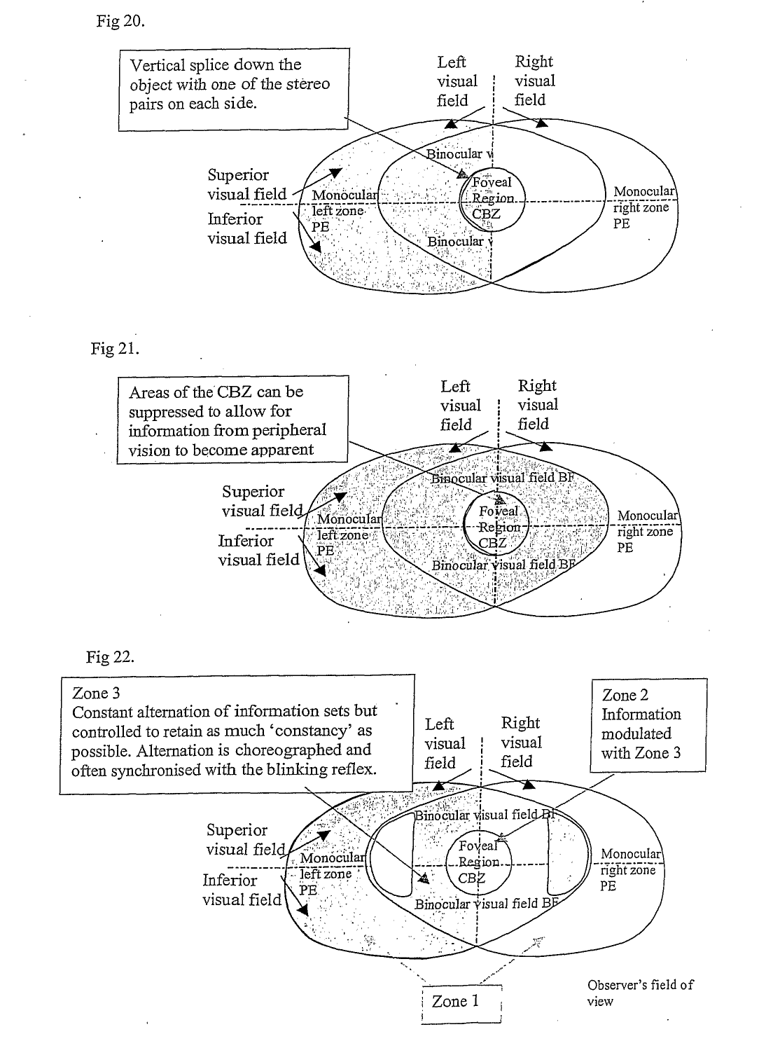

Referring to FIGS. 20 to 22, areas of the central vision information area can be suppressed allowing peripheral vision information to come to consciousness. This has the effect of integrating information appearing in the two regions (central and peripheral).

It's the overarching perceptual structure together with the mechanisms/dynamic that drives it, which generate the non-linear nature of visual perception that contribute so significantly to our heightened sense of spatial awareness and general efficiency in information processing. For representational media to attain a similar impact and attributes for viewers it will need to fragment and be enriched accordingly. We visually contemplate objects and the space they occupy in time.

Understanding these processes identifies that other combinations not used in regular compositions of vision can also be used ‘for special effect’ within representational media.

Object Recognition:

In order for modulation of individual objects to take place in Vision-Space media it is necessary to provide an algorithmic function capable of defining ‘object’. In visual perception we perform this seemingly simple task effortlessly and so give no thought to it. As observers we have the luxury of a memory able to assist with the process of object definition. At a conceptual level we know that its is a vase on the table (2 objects) not a table with a funny profiled surface (1 object).

The specialist algorithm performs the following functions.

The first and most important aspect involved in object recognition in visual field is that we segment areas into ‘object’ in ‘space’. This segmentation occurs within the distinctions of macular (central) vision and peripheral vision. Anything outside the fixation volume of central vision is not capable of object-based modulation into a single form. We are not especially ‘object aware’ in peripheral vision.

The second aspect of the modulation process is that it is not limited to object based segmentation. A wing mirror is attached to a car, but if the mirror is fixated, object based modulation can take place. So the process is not actually about ‘object recognition’. It's more about fixation based modulation of identifiable form.

The task is now about the recognition of forms. The segmentation of the fixation volume through the use of depth-maps provides us with 3D information relating to form. This segmentation defines edges and isolates forms.

Other cues relating to form are deduced by abrupt changes to surface texture and luminance for example. If the vase was sitting on a sheep skin rug for example, the algorithm differentiates between the texture boundaries.

Errors are corrected with manual adjustments. Facilities in the editing tools of postproduction and 3D software packages enable these manual adjustments to be made. In real time simulation, labels or tags are encoded into the 3D object modelling processes. These tags ensure that the computer reads ‘object’ and defines boundaries as the viewer selects that virtual object for scrutiny from within the scene.

In the absence of 3D depth map information, for example in photographic record, more approximate delineations will need to be applied.

Object Composition:

Once information about an object from each eye and each of the two monocular information-sets has been segmented, it is assembled as a Vision-Space binocular stereo super-form. Each segment of information is different either with respect to the vantage point of the viewer (binocular stereo) or by transitional stretch (monocular stereo). Fitting these portions together to form a credible over all shape resembling the shape of the actual 3D object is a task that is likely to require judgment and skill, however there must also be considerable underlying process that can be used to base assembly algorithms. The process is ‘naturally automated’ or unconscious in visual perception.

In the case of a vase for example the final impression of the vase is composed from 4 quadrants. First the form is recognised as such above. Then two monocular views of the form are composed from the two information-sets. Then left hand eye top left quadrant is matched to right hand eye top right quadrant. Then bottom left, left hand quadrant is matched to bottom right, right hand quadrant. This process ensures that binocular stereo information is seeded into a singular representation. This fragmentary assemblage of information sources requires some rules and procedures to ensure that apparent overall unity of the object is maintained. There are overlaps between the information being presented as part of the sets and some alignment issues at junctions between depicted edges.

Modulation, Juxtaposition, Alternation:

Variation of Visual Field in Zone 3:

As we visually interrogate our surrounding we are constantly sampling and resampling aspects of the scene within the armature of visual field. It is important that this sampling process appears to be as seamless and as imperceptible as possible.

Zone 1. Peripheral Extents (PE): At the extreme edges of visual field only monocular vision is available. Only independent monocular Vision-Space RH and LH views of the scene can be formulated.

Binocular Field (BF) contains 2 independent presentation systems for binocular stereo interpretations.

Zone 2. Central Binocular Zone (CBZ): In central vision there is spatially isolated variation of information sets (as below) modulated in a sophisticated and seamless way so as to appear to be ‘constant’ to all but the most acute of subjective evaluations.

Zone 3. Binocular Field (BF): The entire area over which binocular stereo information is available. This is the area subject to most ‘variable’ conditions involving embedded alternation and areas of visual field where information from one eye (camera view) is embedded into information from the other eye (camera view). Zone 2 activity is cascaded into Zone 3.

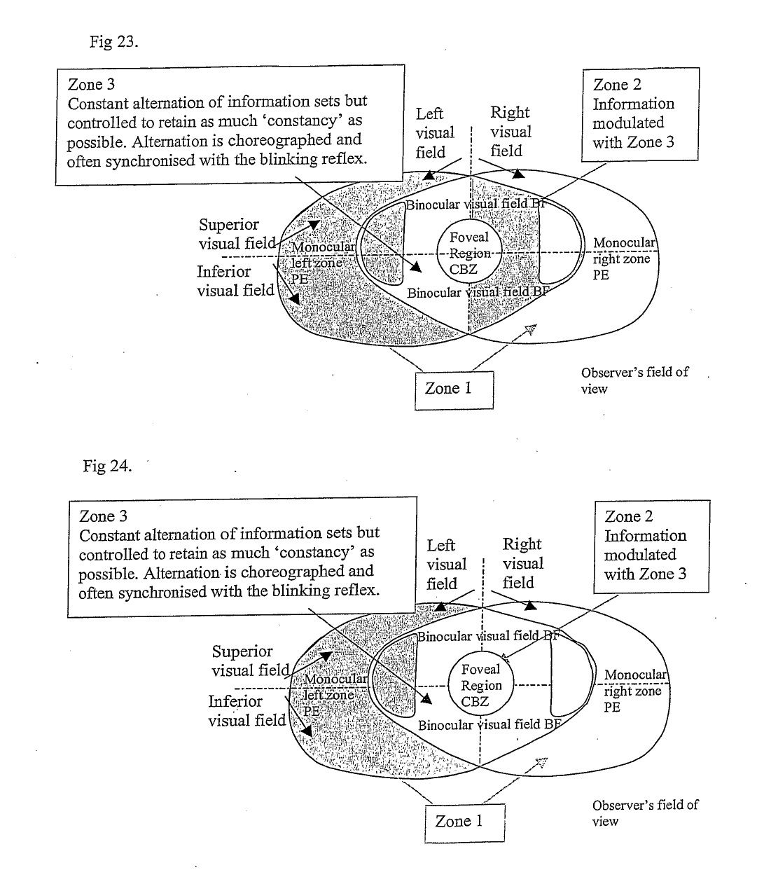

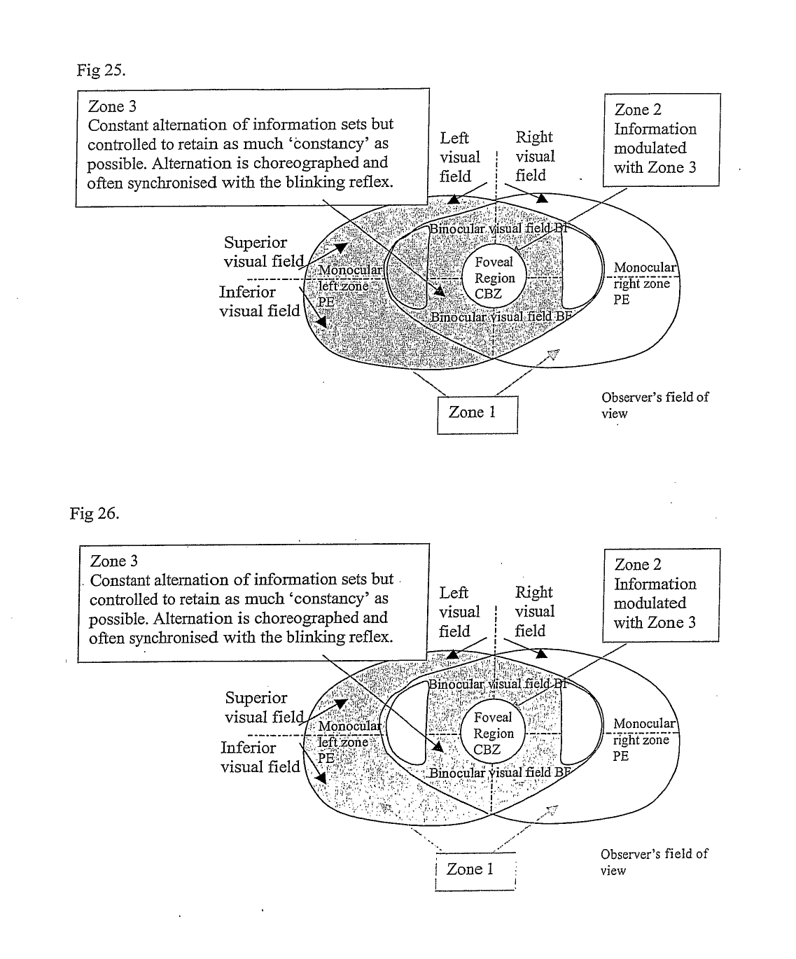

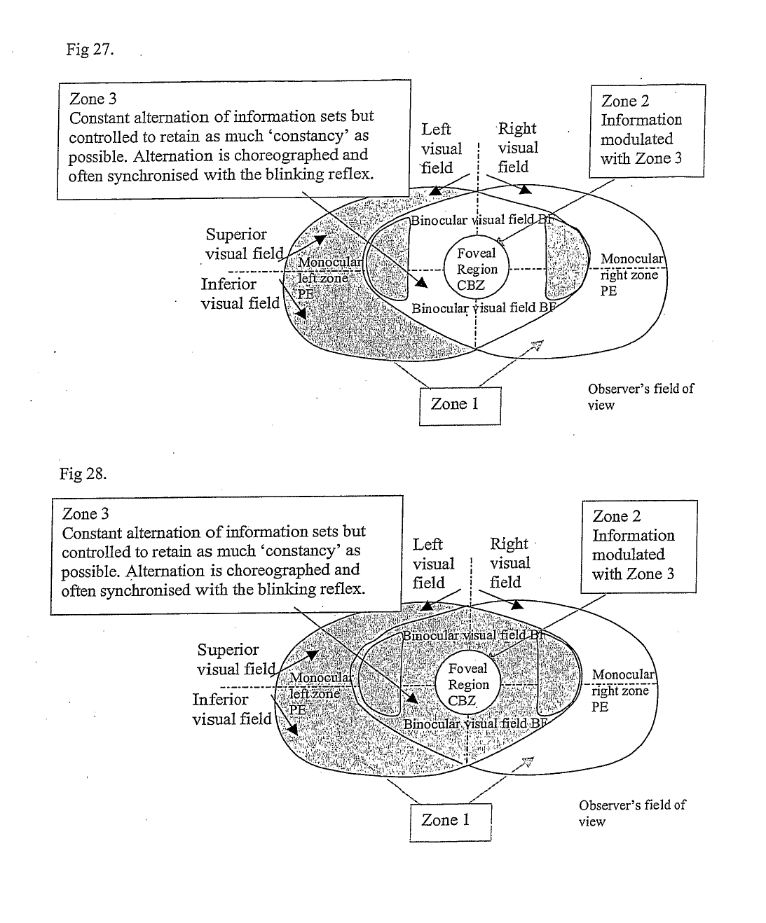

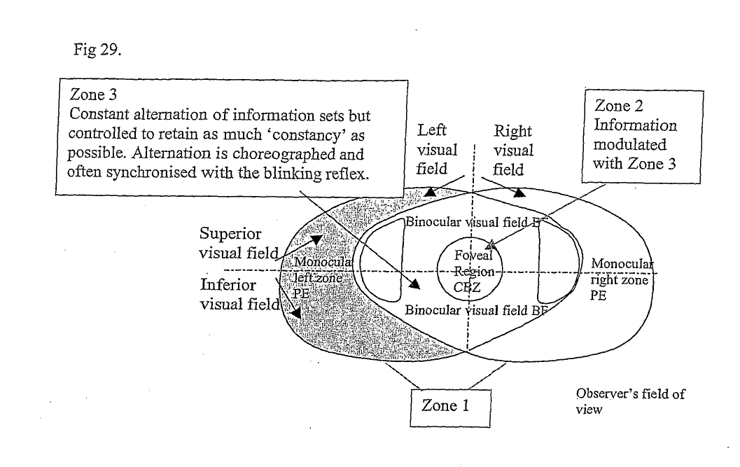

These zones are illustrated in FIGS. 22 to 29.

Other variations may be possible in visual presentation (may vary according to individual). For example in certain situations CBZ modulation may not be required (looking far into the distance) and this process may suppressed. It may be possible to engineer others for use in representational media (for effect) that are not contained in the repertoire of visual perception.

Masking Transitional Processes:

Much of the juxtaposition transition is masked in vision by the blinking reflex. In addition, the human visual system has developed a very useful defence mechanism in the from of ‘change blindness’. We are exceptionally poor at determining small or even substantial changes with a scene over time. As long as there is continuity in the main event being observed, we are to a reasonable degree ‘blind’ to changes going on around this key event or activity.

However, as these various transitional changes between information-sets are entered into representational media, it is anticipated that adaptations will have to be made to ensure that they don't become too obvious to the viewer and hence detract from the viewer experience. For example, the viewer will not be blinking in synchrony with the edited transformations within the media.

One approach is less use of the alternation/embedding processes in peripheral vision with considerably more modulation process.

An alternative procedure is synchronising the decay in saliency experienced in central vision and peripheral vision as a fixation maintained through time (around 10 seconds or less). It can be appreciated in vision that as the central vision data set decays away as part of the modulation function, saliency is also lost from peripheral vision. It appears that the spatial texture providing monocular 3D in peripheral areas also decays. This feature is also reinstated when the blinking reflex refreshes and resets the situation.

When replicated in visual media, the coupling of these decay occurrences provides the director/post production editor with the ability to induce and control the blinking reflex in the viewer. This is a form of perceptual interplay between the dynamic of perception replicated in the media cueing perceptual responses in the audience. In this way it is changes in information display within the media are timed to coincide with induced blinking. This enables the production of more seamless perceptual media.

1. A method of enhancing the perception of an image comprising the steps of:
a. selecting a picture or graphic representation for enhancement;
b. producing two monocular images:
i. monocular image one is a left hand view;
ii. monocular image two is a right hand view;
iii. the point of observation for monocular image one and monocular image two are separated by a horizontal distance of approximately 1 centimeter to 1 meter;
c. creating peripheral monocular extents within the peripheral zone (Zone 1) by:
i. aligning said left hand and right hand peripheral data sets such that the fixation points of the left hand view and right hand view are coincident;
ii. excluding all elements of the two data sets which are in common;
d. creating a central binocular zone (Zone 2) by:
i. selecting the right hand central data set as the dominant central data set;
ii. overlaying and integrating said dominant central data set with the remaining central data set;
e. creating a binocular field (Zone 3) by:
i. aligning said left hand and right hand peripheral data sets such that the fixation points of the left hand view and right hand view are coincident;
ii. including only those elements of the two data sets which are in common; and
f. overlaying and integrating the Zone 1, Zone 2 and Zone 3.

2. A method according to claim 1, wherein the point of observation for monocular image one and monocular image two are separated by a horizontal distance of approximately the distance between a person's eyes.

3. A method according to claim 1, further comprising a step of enhancing each of the right hand view and left hand view monocular images by creating two data sets:
i. the central data set is an area selected around a fixation point; and
ii. the peripheral data set is the entire region disordered as a function of distance from the fixation point.

4. A method according to claim 3, in which the image in the central data set is transformed using the technique described in GB 02400259 and/or “Method and Software for Transforming Images”.

5. A method according to claim 3, in which the image in the peripheral data set is transformed using the technique described in GB 02400259 and/or “Method and Software for Transforming Images”.

6. A method according to claim 1, in which the alignment of the left hand and right hand peripheral data sets in Zone 3 is modulated by varying the information from the two peripheral data sets over time.

7. A method according to claim 1, in which the left hand central data set is selected as the dominant central data set in Zone 2.

8. A method according to claim 1, in which multiple fixation points are selected.

9. A method according to claim 1, in which the degree of dominance in the central data set is varied over time.

10. A method according to claim 1, in which the alignment of the left hand and right hand central data sets is modulated by varying the information from the two central data sets in Zone 2 over time.

11. A method according to claim 1, in which transparency or interlacing are used to overlay or integrate Zone 1, Zone 2 and/or Zone 3.

12. A method according to claim 1, in which special effects/enhancements are induced by setting said horizontal distance to less than 1 centimeter or greater than 1 meter.

13. A method according to claim 1, in which any one or two of Zone 1, Zone 2 or Zone 3 are totally or partially eliminated.

14. A method according to claim 1, in which transparency or interlacing are used to overlay or integrate the left hand and right hand peripheral data sets.

15. A method according to claim 1, in which transparency or interlacing are used to overlay or integrate the peripheral zone and the binocular zone.

16. A method of enhancing the perception of a stereoscopic images comprising the steps of:
a. selecting a stereoscopic pair of pictures or graphic representations for enhancement;
b. producing two monocular images from each of the stereoscopic pair:
i. monocular image one is a left hand view
ii. monocular image two is a right hand view
c. enhancing each of the right hand view and left hand view monocular images by creating two data sets:
i. the central data set is an area selected around a fixation point;
ii. the peripheral data set is the entire region disordered as a function of distance from the fixation point;
d. creating peripheral monocular extents within the peripheral zone (Zone 1) by:
i. aligning said left hand and right hand peripheral data sets such that the fixation points of the left hand view and right hand view are coincident;
ii. excluding all elements of the two data sets which are in common;
e. creating a binocular field (Zone 3) by:
i. aligning said left hand and right hand peripheral data sets such that the fixation points of the left hand view and right hand view are coincident;
ii. Including only those elements of the two data sets which are in common; and
f. creating the enhanced image by:
i. overlaying and integrating the Zone 1 and Zone 3 with the original stereoscopic pair of images;
ii. and transmitting the right hand and left hand central data sets to each eye of the viewer.

17. A method according to claim 16, in which the left hand and right hand central data sets are transmitted through means comprising
a. polarized stereo glasses
b. cross converged viewing, with prismatic “masking” glasses.
c. liquid crystal shutter glasses
d. linearly polarized glasses
e. circularly polarized glasses
f. ompensating diopter glasses
g. ColorCode 3D
h. Chromadepth glasses
i. anachrome optical diopter glasses
j. random-dot auto stereograms
k. prismatic & self masking crossview glasses
l. LCD displays covered with an array of prisms that divert the light from odd and even pixel columns to left and right eyes respectively.

18. The method according to claim 16, in which the image in the peripheral data set is transformed as described in GB 02400259 and/or “Method and Software for Transforming Images”.

19. The method according to claim 16, in which the alignment of the left hand and right hand peripheral data sets in Zone 3 is modulated by varying the information from the two peripheral data sets over time.

20. The method according to claim 16, in which transparency or interlacing are used to overlay or integrate Zone 1, Zone 2 and/or Zone 3.

21. The method according to claim 16, in which Zone 1 and/or Zone 3 are totally or partially eliminated.

22. The method according to claim 16, in which transparency or interlacing are used to overlay or integrate the left hand and right hand peripheral data sets.

23. The method according to claim 16, in which transparency or interlacing are used to overlay or integrate the peripheral zone and the binocular zone.
